(19) United States
(12) Patent Application Publication
(10) Pub. No.: US 2021/0401232 A1
(43) Pub. Date: Dec. 30, 2021

(54) MULTIFUNCTIONAL COOKING UTENSIL

(71) Applicant: Yangjiang City Xiangmao Trading Co., Ltd., Yangjiang City (CN)

(72) Inventor: Guimin Li, Benxi City (CN)

(21) Appl. No.: 16/921,258

(22) Filed: Jul. 6, 2020

(30) Foreign Application Priority Data
Jun. 27, 2020 (CN) 202021201599.2

(51) Int. Cl. A47J 43/28; B26B 5/00; B26B 11/00; B26B 13/04

(52) U.S. Cl. CPC A47J 43/288; A47J 43/281; B26B 13/04; B26B 5/00; B26B 11/005; A47J 43/283

(57) ABSTRACT

The present disclosure provides a multifunctional cooking utensil. The multifunctional cooking utensil includes a kitchen knife, a toothed knife, a fork, a turning shovel, and a spoon. The kitchen knife and the toothed knife are assembled to form scissors. The fork and the turning shovel are assembled to form a water filter food clip. The spoon and the fork are assembled to form a water receiving food clip. With the above structure, the cooking utensil implements the functions of the knife, the fork, the turning shovel, the toothed knife, the scissors, and the food clips, and may be applied to restaurants, barbecue restaurants, hotels, and home kitchens, and achieves an integrated use of a plurality of tools.

### TECHNICAL FIELD

The present disclosure relates to the technical field of household kitchen utensils, and in particular, relates to a multifunctional cooking utensil.

### BACKGROUND

With constant improvement of people's living standard, in well-off families diversified kitchen utensils are being used, for example, kitchen knives, toothed knives, forks, turning shovels, spoons, clips, and scissors, which are all commonly used utensils in modern families. However, in the related art, the kitchen knife, the toothed knife, the fork, the turning shovel, the spoon, the clip, and the scissors are mostly separately manufactured or machined. Since these kitchen tools are conventionally structured and have single functions, a large amount of space and a large quantity of resources are unnecessarily consumed. At present, in urban areas, the dwelling price is extremely high, and the area of the kitchen of a house is very limited. Especially, in Hong Kong and Macao of China, Europe, Japan, and other developed countries, due to the high dwelling price, the kitchens are generally very small and narrow, and the minimum kitchen may be one to two square meters. Therefore, deployment of such independent utensils in such small and narrow kitchens may scarify the limited space of the kitchens. Accordingly, an inventive concept of the present disclosure is to design a detachable multifunctional cooking utensil integrating uses of a plurality of tools.

### SUMMARY

To overcome the defects in the related art, the present disclosure provides a novel multifunctional cooking utensil integrated with a plurality of tools which features simple structure, compactness, and convenience and practicability.

The objectives of the present disclosure are achieved by employing the following technical solution:

According to a technical solution of the present disclosure, a multifunctional cooking utensil includes: a kitchen knife, a toothed knife, a fork, a turning shovel, and a spoon; wherein the kitchen knife is provided with a first locking hole, a cutting edge, a bottle cap opener, a circular handle, and a first receiving piece;

the toothed knife is provided with a first T-shaped locker, a tooth, a fork knife, a circular handle, and a first barb, wherein the T-shaped locker is provided with a pin shaft thereunder configured to guide the kitchen knife to rotate, and the first T-shaped locker is movably connected to the first locking hole to form scissors;

a head of the fork is tilted and slightly bent, and a handle of the fork is provided with a second locking hole and a second receiving piece;

a head of the turning shovel is hollowed out in the middle thereof and a toothed edge region is arranged on a side of the hollowed-out portion, and a handle of the turning shovel is provided with a second T-shaped locker, a pin shaft, and a second barb, wherein the second T-shaped locker is movably connected to the second locking hole to form a water filter food clip; and

the spoon is provided with a third T-shaped locker, a pin shaft, and a third barb, wherein the third T-shaped locker is movably connected to the second locking hole to form a water receiving food clip.

Further, the scissors are detachable, the kitchen knife and the toothed knife are assembled to form the scissors, and the scissors are used as a separate kitchen knife and a separate toothed knife after being disassembled.

Further, the water filter food clip and the water receiving food clip are both detachable, wherein the fork and the turning shovel are assembled to form the water filter food clip, the fork and the spoon are assembled to form the water receiving food clip, the water filter food clip is used as a separate fork and a separate turning shovel after being disassembled, and the after receiving food clip is used as a separate fork and a separate spoon after being disassembled.

As compared with the related art, the present disclosure has the following advantages:

With the above structure, the cooking utensil implements the functions of the knife, the fork, the turning shovel, the toothed knife, the scissors, and the food clips, and may be applied to restaurants, barbecue restaurants, hotels, and home kitchens, regardless of outdoors and indoors. The cooking utensil according to the present disclosure features a simple structure, a smart and delicate design, a novel style, a wide applicable scope, and high practicability.

In addition to the above described objects, features, and advantages, the present disclosure still has other objects, features, and advantages. The present disclosure is further described hereinafter with reference to the accompanying drawings.

### BRIEF DESCRIPTION OF THE DRAWINGS

The accompanying drawings herein, which are incorporated herein and constitute a part of the specification, illustrate several exemplary embodiments of the present disclosure and together with the description, serve to illustrate the present disclosure, construing no limitation to the present disclosure. In the drawings:

FIG. 1 is a schematic structural view of a multifunctional cooking utensil according to a preferred embodiment of the present disclosure;

FIG. 2 is a schematic view of a process of assembling a kitchen knife and a toothed knife to form scissors of the multifunctional cooking utensil according to a preferred embodiment of the present disclosure;

FIG. 3 is a schematic structural view of the scissors formed by assembling kitchen knife and a toothed knife of the multifunctional cooking utensil according to a preferred embodiment of the present disclosure;

FIG. 4 is a schematic view of a process of assembling a fork and a turning shovel to form a water filter food clip of the multifunctional cooking utensil according to a preferred embodiment of the present disclosure;

FIG. 5 is a schematic structural view of the water filter food clip formed by assembling the fork and the turning shovel of the multifunctional cooking utensil according to a preferred embodiment of the present disclosure;

FIG. 6 is a schematic view of a process of assembling the fork and a spoon to form a water receiving food clip of the multifunctional cooking utensil according to a preferred embodiment of the present disclosure;

FIG. 7 is a schematic structural view of the water receiving food clip formed by assembling the fork and the spoon the multifunctional cooking utensil according to a preferred embodiment of the present disclosure;

FIG. 8 is a schematic structural view of another side of the water receiving food clip of the multifunctional cooking utensil according to a preferred embodiment of the present disclosure; and

FIG. 9 is a schematic structural view of another side of the spoon of the multifunctional cooking utensil according to a preferred embodiment of the present disclosure.

### DETAILED DESCRIPTION

It needs to be noted that in case of no conflict, the embodiments and features in the embodiments of the present disclosure may be combined together. The present disclosure is described hereinafter in detail with reference to the accompanying drawings and specific embodiments.

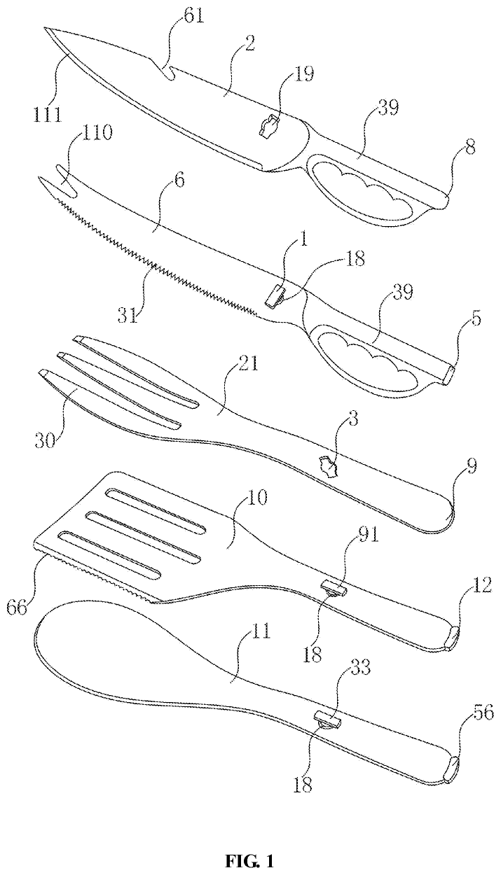

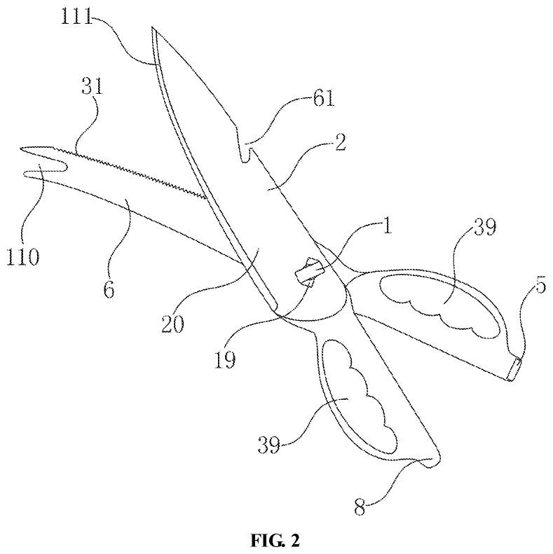

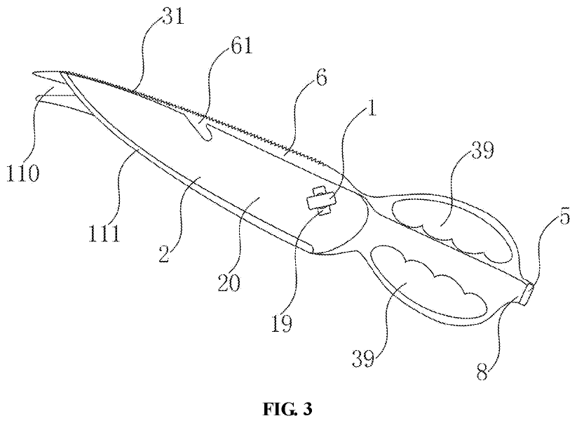

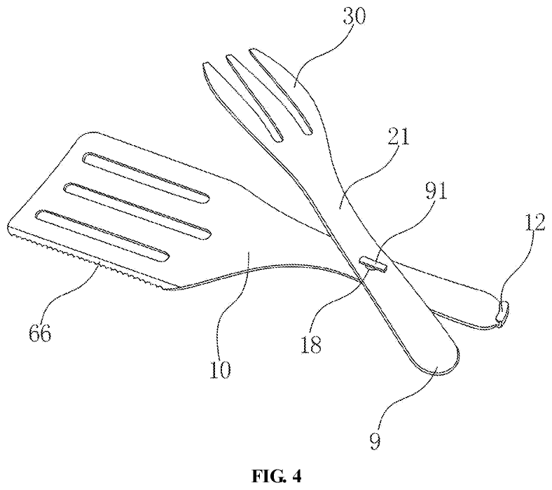

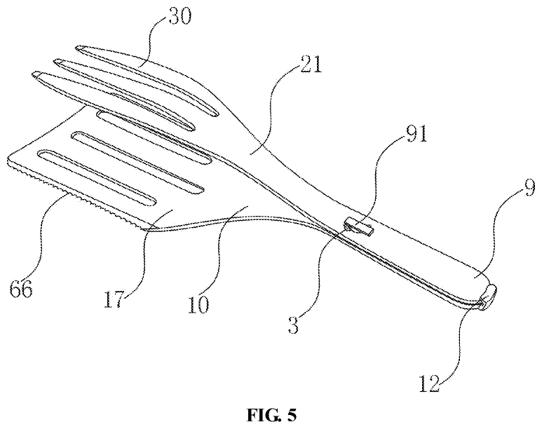

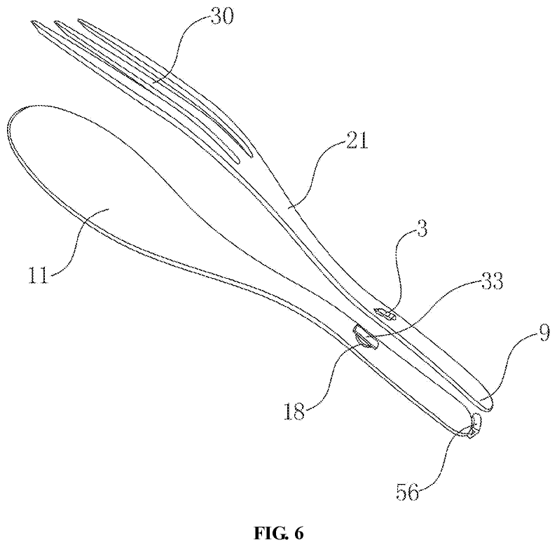

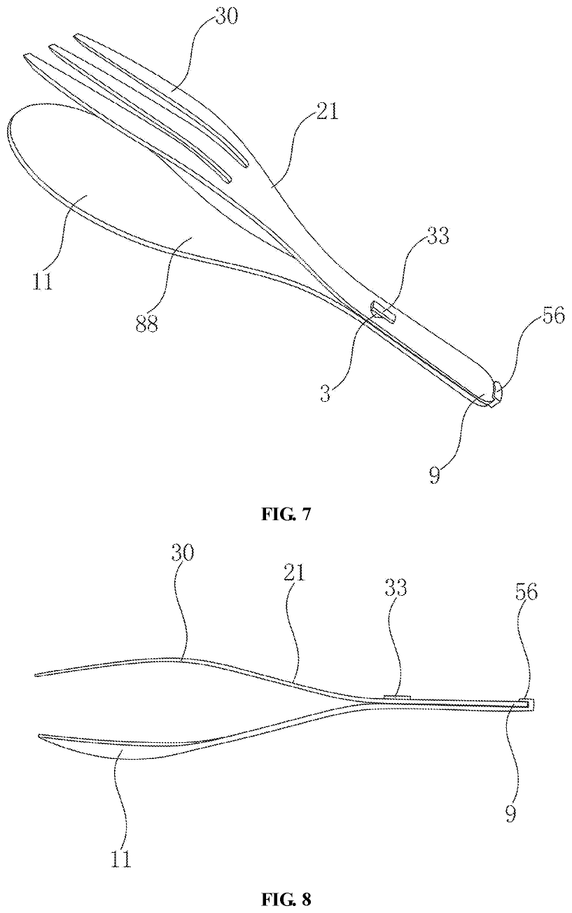

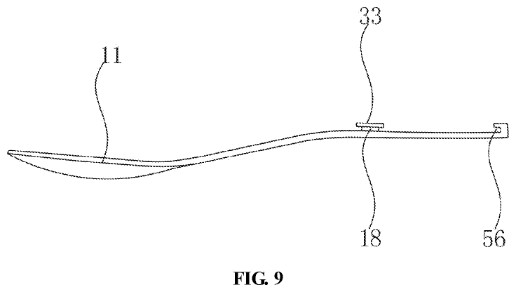

As illustrated in FIG. 1, FIG. 2, FIG. 3, FIG. 4, FIG. 5, FIG. 6, FIG. 7, FIG. 8, and FIG. 9, the present disclosure provides a multifunctional cooking utensil. The multifunctional cooking utensil includes: a kitchen knife 2, a toothed knife 6, a fork 21, a turning shovel 10, and a spoon 11. The kitchen knife is provided with a first locking hole 19, a cutting edge 111, a bottle cap opener 61, a circular handle 39, and a first receiving piece 8.

The toothed knife 6 is provided with a first T-shaped locker 1, a tooth 31, a fork knife 110, a circular handle 39, and a first barb 5; wherein the teeth may be configured to cut frozen meat, the fork knife may be configured to disrupt guts of fowls, the T-shaped locker is provided with a pin shaft 18 thereunder configured to guide the kitchen knife to rotate, the first T-shaped locker is movably connected to the first locking hole 19 to form scissors 20, and the kitchen knife 2 is locked by engaging the first receiving piece 8 with the first barb 5. In this way, the kitchen knife is effectively prevented from rotatably opening during placement of the knife, and thus use safety is ensured and safety risks are prevented.

A head 30 of the fork 21 is tilted and slightly bent, and a handle of the fork is provided with a second locking hole 3 and a second receiving piece 9.

A head of the turning shovel 10 is hollowed out in the middle thereof and a toothed edge region 66 configured to cut cooked food is arranged on a side of the hollowed-out portion, and a handle of the turning shovel is provided with a second T-shaped locker 91, a pin shaft 18, and a second barb 12, wherein the second T-shaped locker 91 is movably connected to the second locking hole 3 to form a water filter food clip 17, and the second receiving piece 9 is engaged with the second barb 12 such that the water filter food clip is provided with an elastic force which opens the head of the fork and the head of the turning shovel.

Preferably, the spoon 11 is provided with a third T-shaped locker 33, a pin shaft 18, and a third barb 56, wherein the third T-shaped locker is movably connected to the second locking hole 3 to form a water receiving food clip 88. In this way, people may take soup when clipping the food.

The scissors 20 are detachable, the kitchen knife and the toothed knife are assembled to form the scissors, and the scissors are used as a separate kitchen knife and a separate toothed knife after being disassembled.

The water filter food clip 17 and the water receiving food clip 88 are both detachable, wherein the fork and the turning shovel are assembled to form the water filter food clip, the fork and the spoon are assembled to form the water receiving food clip, the water filter food clip is used as a separate fork and a separate turning shovel after being disassembled, and the after receiving food clip is used as a separate fork and a separate spoon after being disassembled.

Preferably, the cooking utensil according to the present disclosure integrally implements the functions of the knife, the fork, the spoon, the turning shovel, the toothed knife, the scissors, the water filter food clip, the water receiving food clip, and is a multifunctional tool kit applicable to restaurants, barbecue, household uses, and the like. This cooking utensil is a novel and contributive tool, and saves a large amount of space and resources.

Preferably, the kitchen knife 2, the toothed knife 6, the fork 21, the turning shovel 10, and the spoon 11 are packaged in one package box, and users only need to carry the package box either indoors or outdoors, and all the contained tools may be used where necessary in any place. The cooking utensil features multifunctionality, and implements an integrated use of a plurality of tools.

The above described embodiments are merely preferred embodiments of the present disclosure, but are not intended to limit the present disclosure. A person skilled in the art would derive various modifications and variations based on these embodiments. Any modification, equivalent replacement, and improvement made without departing from the spirit and principle of the present disclosure shall fall within the protection scope of the present disclosure.

What is claimed is:

1. A multifunctional cooking utensil, comprising: a kitchen knife (2), a toothed knife (6), a fork (21), a turning shovel (10), and a spoon (11); wherein the kitchen knife is provided with a first locking hole (19), a cutting edge (111), a bottle cap opener (61), a circular handle (39), and a first receiving piece (8);
the toothed knife (6) is provided with a first T-shaped locker (1), a tooth (31), a fork knife (110), a circular handle (39), and a first barb (5), wherein the T-shaped locker is provided with a pin shaft (18) thereunder configured to guide the kitchen knife to rotate, and the first T-shaped locker is movably connected to the first locking hole (19) to form scissors (20);
a head (30) of the fork (21) is tilted and slightly bent, and a handle of the fork is provided with a second locking hole (3) and a second receiving piece (9);
a head of the turning shovel (10) is hollowed out in the middle thereof and a toothed edge region (66) is arranged on a side of the hollowed-out portion, and a handle of the turning shovel is provided with a second T-shaped locker (91), a pin shaft (18), and a second barb (12), wherein the second T-shaped locker (91) is movably connected to the second locking hole (3) to form a water filter food clip (17); and
the spoon (11) is provided with a third T-shaped locker (33), a pin shaft (18), and a third barb (56), wherein the third T-shaped locker is movably connected to the second locking hole (3) to form a water receiving food clip (88).

2. The multifunctional cooking utensil according to claim 1, wherein the scissors (20) are detachable, the kitchen knife and the toothed knife are assembled to form the scissors, and the scissors are used as a separate kitchen knife and a separate toothed knife after being disassembled.

3. The multifunctional cooking utensil according to claim 1, wherein the water filter food clip (17) and the water receiving food clip (88) are both detachable, wherein the fork and the turning shovel are assembled to form the water filter food clip, the fork and the spoon are assembled to form the water receiving food clip, the water filter food clip is used as a separate fork and a separate turning shovel after being disassembled, and the after receiving food clip is used as a separate fork and a separate spoon after being disassembled.
